(19) United States
(12) Patent Application Publication
(10) Pub. No.: US 2014/0046968 A1
(43) Pub. Date: Feb. 13, 2014

(54) DATA ACQUISITION METHOD, DEVICE AND SYSTEM

(71) Applicant: Qing Yuan, Shenzhen City (CN)

(72) Inventor: Qing Yuan, Shenzhen City (CN)

(73) Assignee: TENCENT TECHNOLOGY (SHENZHEN) COMPANY LIMITED, Shenzhen City, Guangdong, CN (CN)

(21) Appl. No.: 14/111,494

(22) PCT Filed: Apr. 6, 2012
(86) PCT No.: PCT/CN2012/073584

§ 371 Date: Oct. 11, 2013

(30) Foreign Application Priority Data
Apr. 15, 2011 (CN) 201110095563.X

(51) Int. Cl. G06F 17/30

(52) U.S. Cl. CPC G06F 17/30386
USPC 707/758

(57) ABSTRACT

The present invention discloses a data acquisition method, including: receiving at least one first data acquisition request, wherein the first data acquisition request carries a data selection condition; acquiring all the data identifiers satisfying the data selection condition according to the data selection condition; and concurrently acquiring all the data corresponding to the data identifiers according to the data identifiers, and returning the acquired data. Also disclosed is a data acquisition apparatus, including: a data acquisition request receiving module, a data identifier acquiring module, and a first data acquiring module. According to the embodiments of the present invention, data identifiers are determined according to a data selection condition, and all the data corresponding to the data identifiers is concurrently acquired according to the data identifiers, thereby reducing a data feedback delay caused by successive acquisition of data in the prior art. Concurrent acquisition of the data improves data acquisition efficiency, such that the data is timely feedback to a user and user satisfaction of a data user is enhanced.

This application claims priority to Chinese Patent Application No. 201110095563x, filed before Chinese Patent Office on Apr. 15, 2011 and entitled “DATA ACQUISITION METHOD, DEVICE AND SYSTEM”, which is incorporated herein by reference in its entirety.

### FIELD OF THE INVENTION

The present invention relates to the field of communications technologies, and in particular, to a data acquisition method, device and system.

### BACKGROUND OF THE INVENTION

In microblog systems, with the increase of the number of users and the amount of information posted by each of the users, the data generated in the systems explode sharply, such that mass data is formed. When a microblog user uses the microblog system, the user can acquire his or her desired data from the mass data stored in the system by using the way provided in the system such as by searching. How to present the mass data to the mass users quickly is a difficulty for the background technologies of the microblog system.

In the prior art, when a microblog information acquisition system receives a data acquisition request from a user, all data satisfying a data selection condition set by the user is selected and presented to the user. For example, microblog user A is followed by three other microblog users C, D, and F; when microblog user B requests information of those who follow microblog user A, the microblog information acquisition system firstly establishes a connection with a microblog information storage system to acquire information of user C, and upon receiving returned information of user C, establishes a connection with the microblog information storage system to acquire information of user D, and upon receiving returned information of user D, establishes a connection with a storage server to acquire information of user F. After information of users C, D, and F is completely acquired, the microlog information acquisition system returns the acquired information of users C, D, and F to user B.

The prior art has the following defect:

In conventional microblog systems, during processing of user data acquisition requests, the data desired has to be acquired on a one-by-one basis. To be specific, a piece of data can be acquired only after the previous piece of data has been acquired. This increases the waiting delay in acquisition of the overall data.

### SUMMARY OF THE INVENTION

To shorten the waiting delay of a user in data acquisition, an embodiment of the present invention provides a data acquisition method. The method includes:

receiving at least one first data acquisition request, where the first data acquisition request carries a data selection condition;

acquiring all the data identifiers satisfying the data selection condition according to the data selection condition; and

concurrently acquiring all the data corresponding to the data identifiers according to the data identifiers, and returning the acquired data.

An embodiment of the present invention provides a data acquisition device. The device includes:

a data acquisition request receiving module, configured to receive at least one first data acquisition request, where the first data acquisition request carries a data selection condition;

a data identifier acquiring module, configured to acquire all the data identifiers satisfying the data selection condition according to the data selection condition; and

a first data acquiring module, configured to concurrently acquire all the data corresponding to the data identifiers according to the data identifiers, and return the acquired data.

An embodiment of the present invention provides a terminal. The terminal includes the above described data acquisition device.

An embodiment of the present invention provides a data storage server. The server includes:

a receiving module, configured to receive a second data acquisition request concurrently sent by a terminal, where the second data acquisition request is generated by the terminal according to data identifiers and a preset packet format;

an acquiring module, configured to acquire the data corresponding to the data identifiers according to the data identifiers; and

a returning module, configured to return the data corresponding to the data identifiers acquired by the acquiring module.

An embodiment of the present invention provides a data acquisition system. The system includes the terminal described above, and the data storage server described above.

According to the embodiments of the present invention, data identifiers are determined according to a data selection condition, and all the data corresponding to the data identifiers is concurrently acquired according to the data identifiers, thereby reducing a data feedback delay caused by successive acquisition of data in the prior art. Concurrent acquisition of the data improves data acquisition efficiency, such that the data is timely feedback to a user and user satisfaction of a data user is enhanced.

### BRIEF DESCRIPTION OF THE DRAWINGS

FIG. 1 is a flowchart of a data acquisition method according to Embodiment 1 of the present invention;

FIG. 2 is a flowchart of a data acquisition method according to Embodiment 2 of the present invention;

FIG. 3 is a flowchart of a data acquisition method according to Embodiment 3 of the present invention;

FIG. 4 is a schematic diagram of a data acquisition device according to Embodiment 4 of the present invention;

FIG. 5 is a schematic diagram of a data acquisition device according to Embodiment 5 of the present invention; and

FIG. 6 is a schematic diagram of a data storage server according to Embodiment 6 of the present invention.

### DETAILED DESCRIPTION OF THE INVENTION

To make the technical solutions and advantages of the present invention clearer, the embodiments of the present invention are described in detail below with reference to the accompanying drawings.

### Embodiment 1

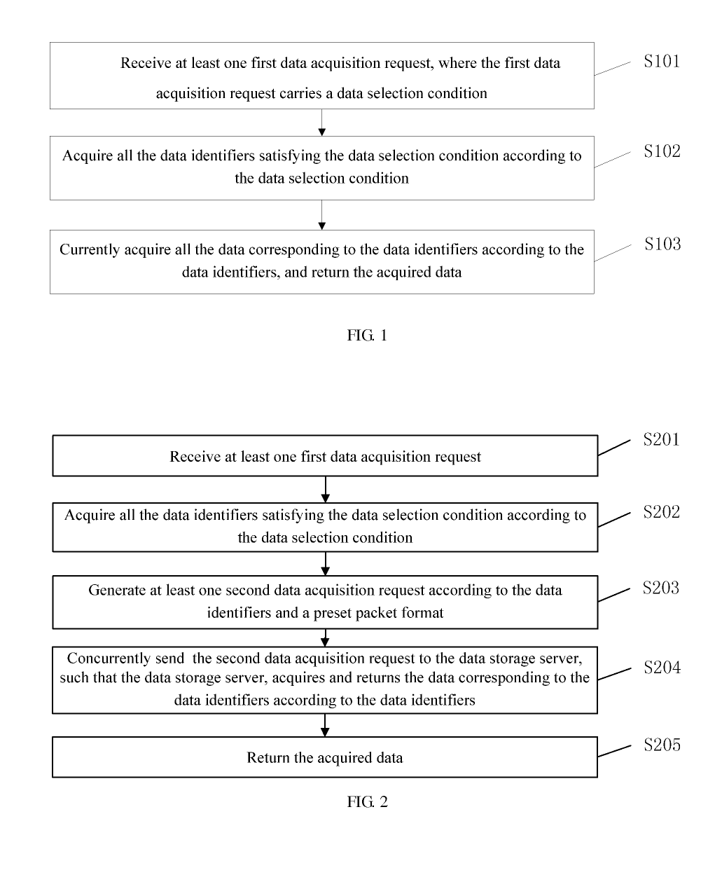

As illustrated in FIG. 1, this embodiment provides a data acquisition method. The method includes the following steps:

S101: receiving at least one first data acquisition request, where the first data acquisition request carries a data selection condition;

S102: acquiring all the data identifiers satisfying the data selection condition according to the data selection condition; and

S103: concurrently acquiring all the data corresponding to the data identifiers according to the data identifiers, and returning the acquired data.

It should be noted that the steps in this embodiment may be either performed by a server for acquiring data, or performed by other devices having the functions described in the steps in this embodiment, which is not limited in this embodiment.

According to the embodiments of the present invention, all data identifiers satisfying the data selection condition are acquired, and all the data corresponding to the data identifiers are concurrently acquired according to the data identifiers, thereby reducing a data feedback delay caused by successive acquisition of data in the prior art. Concurrent acquisition of the data improves data acquisition efficiency, such that the data is timely fed back to a user and user satisfaction is enhanced.

### Embodiment 2

As illustrated in FIG. 2, this embodiment provides a data acquisition method. The method includes the following steps:

S201: Receiving at least one first data acquisition request.

In this embodiment, a first data acquisition request is received within a preset duration, where one or a plurality of first data acquisition requests may be received, which is not limited in this embodiment. The first data acquisition request carries a data selection condition, and is used to request and acquire at least one piece of data satisfying the data selection condition. The preset duration may be 30 seconds, 60 seconds, or 90 seconds, which is not limited in this embodiment.

For example, using a microblog system as an example, when microblog user A is followed by three other microblog users, and microblog user B can acquire, by sending a first data acquisition request, information of the microblog users who follow microblog user A, then the data selection condition carried in the first data acquisition request is “those who follow user A”; within a preset duration, microblog user L also sends a first data acquisition request to acquire information of the microblog users who follow microblog user A, then the data selection condition carried in the first data acquisition request is also “those who follow user A”. Assuredly, within the preset duration, other microblog users may also send a first data acquisition request to acquire information of the microblog users who follow microblog user A, which is not limited in this embodiment.

S202: Acquiring all the data identifiers satisfying the data selection condition according to the data selection condition.

In this embodiment, a mapping relationship between data selection conditions and data identifiers is pre-stored locally. In this way, when the first data acquisition request is received, the data identifiers corresponding to the data selection condition are acquired by querying in the locally stored mapping relationship between data selection conditions and data identifiers. The data identifier is used to acquire the data corresponding thereto. Optionally, when the data is physical data, the data identifier thereof may be the physical storage position and reading manner of the physical data.

For example, the locally stored mapping relationship between data selection conditions and data identifiers is listed in Table 1. When the data selection condition is “those who follow user A” as described in step S201, the data identifiers corresponding to the data selection condition are C1, D1, and F1.

TABLE 1

| Data Acquisition | |
|---|---|
| Condition | Data Identifier |
| Those who | C1 |
| follow user A | D1 |
| | F1 |
| Those who | W1 |
| follow user M | Y1 |
| | Z1 |

Optionally, when at least two first data acquisition requests are received within the preset duration, all the data identifiers satisfying the data selection conditions may be combined to acquire combined data identifiers. The combined data identifiers include no identical data identifiers. Additionally, the combined data identifiers are used as data identifiers in the subsequent steps.

For example, if the preset duration is 1 minute, two first data acquisition requests are received within the 1 minute, and the data identifiers corresponding to the data selection conditions carried in the two data acquisition requests are “C1, D1, and F1” and “C1 and D1” respectively, then the combined data identifiers are C1, D1, and F1.

S203: Generating at least one second data acquisition request according to the data identifiers and a preset packet format.

In this embodiment, the second data acquisition request carries at least one data identifier, where the total number of bytes of the data identifiers is smaller than or equal to the maximum number of bytes allowed in the packet format. The preset packet format may be any packet format for data transmission corresponding to existing communication protocols, for example, a packet format corresponding to User Datagram Protocol (UDP) or Transmission Control Protocol (TCP).

For example, as described in step S202, when the preset packet format is a packet format corresponding to UDP, and the acquired data identifiers corresponding to the data selection condition “those who follow user A” are C1, D1, and F1, the second data acquisition request generated according to the data identifiers and the preset packet format is a UDP packet carrying the data identifiers C1, D1 and F1.

Furthermore and optionally, the preset packet format may be determined according to the communication protocol employed for communication between a server and a data storage server. Preferably, UDP may also be employed. Furthermore and preferably, when the second data acquisition request is generated according to the preset packet format, and one packet is unable to contain all data identifiers, then the number of stored bytes of the data identifiers are uniformly divided according to the maximum number of bytes allowed in the packet format, and thus all the data identifiers are sent over a plurality of packets. In addition, the server may negotiate with the data storage server, and the background returns the requested amount of data for each request. For example, assume that a celebrity has 10 thousand fans in the microblog system, a microblog user requests all the celebrity's fans, and the server communicates with the data storage server over UDP; since each UDP packet is able to contain a maximum of 500 data identifiers, 20 data acquisition requests may be concurrently sent to the data storage server. The data request start positions are respectively the 0^{th} data identifier, the 500^{th} data identifier, the 1000^{th} data identifier, . . . , the 9500^{th} data identifier. Upon receipt of the data requests, the data storage server concurrently processes the requests and returns the data.

In this embodiment, when, in step S201, at least two first data acquisition requests are received within the preset duration, at least one second data acquisition request is generated according to the combined data identifiers and the preset packet format. The specific process of generating the second data acquisition request is similar to the above-described process, which is not described herein any further.

S204: Concurrently sending the second data acquisition request to the data storage server, such that the data storage server acquires and returns the data corresponding to the data identifiers according to the data identifiers.

In this embodiment, the second data acquisition request is concurrently sent to the data storage server such that the data storage server queries the locally stored mapping relationship between data identifiers and data; and the data storage server acquires the data corresponding to the data identifiers and returns the acquired data.

For example, the locally stored mapping relationship between data identifiers and data is listed in Table 2. As described in step S203, when the packet received by the data storage server is a UDP packet carrying the data identifiers C1, D1, and F1, the data storage server queries in Table 2 to acquire the data 101, 111, and 110 corresponding to C1, D1, and F1, and returns the acquired data 101, 111, and 110. In this embodiment, the data may be stored in a plurality of manners, which is not limited in this embodiment.

TABLE 2

| Data | |
|---|---|
| Identifier | Data (may be stored in a plurality of manners) |
| C1 | 101 |
| D1 | 111 |
| F1 | 110 |
| . . . | . . . |

S205: Returning the acquired data.

In this embodiment, the subject for performing the steps converts the acquired data into a data format that can be displayed on the terminal, and sends the same to the user.

Optionally, it is judged whether the acquired data satisfies a preset cache condition, and if true, a mapping relationship between the data identifiers and the data is generated, and the mapping relationship is cached in the locally stored mapping relationship between data identifiers and data. The operation is optional, which may not be performed in practice.

Furthermore and optionally, a validity period may be set for storage of the mapping relationship between the data identifiers and the data in the locally stored mapping relationship between data identifiers and data; if a duration when the mapping relationship between the data identifiers and the data is locally cached exceeds the validity period, the mapping relationship between the data identifiers and the data is deleted from the locally cached mapping relationship between data identifiers and data.

For example, the locally stored mapping relationship between data identifiers and data is listed in Table 3, and the validity period of the mapping relationship may further lists.

TABLE 3

| Data Selection Condition | Data | Validity Period |
|---|---|---|
| C1 | 101 | 5 minutes |
| D1 | 111 | |
| F1 | 110 | |
| Those who concern for user C | 1110 | 10 minutes |
| . . . | . . . | 5 minutes |

According to the embodiments of the present invention, data identifiers are determined according to a data selection condition, and all the data corresponding to the data identifiers is concurrently acquired according to the data identifiers, thereby reducing a data feedback delay caused by successive acquisition of data in the prior art. Concurrent acquisition of the data improves data acquisition efficiency, such that the data is timely feedback to a user and user satisfaction of a data user is enhanced.

### Embodiment 3

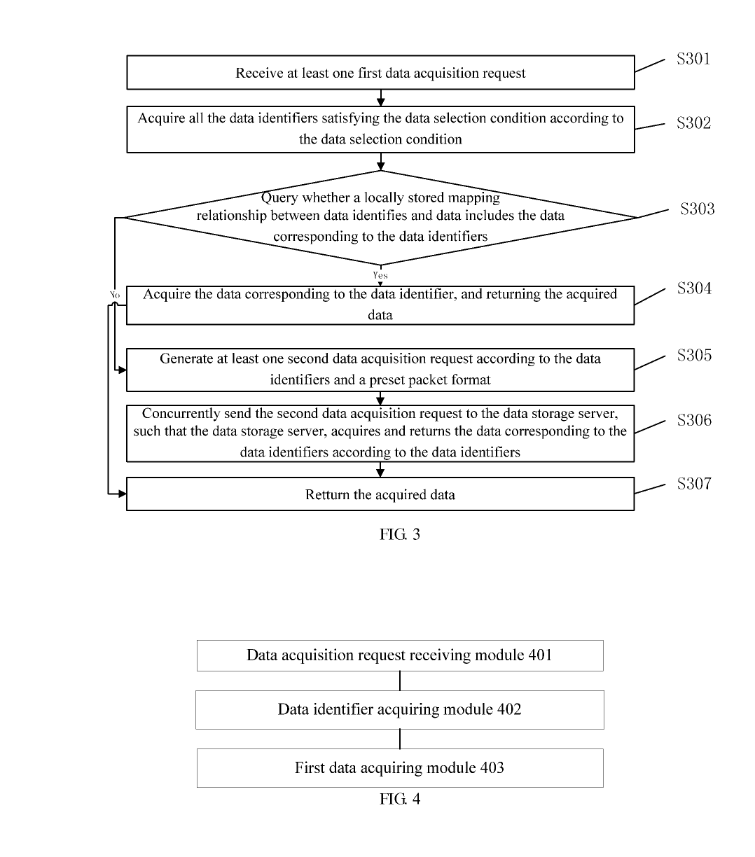

As illustrated in FIG. 3, this embodiment provides a data acquisition method. The method includes steps S301-S307, where steps S301-S302 are similar to steps S201-S202 in Embodiment 2, and steps S305-S307 are similar to steps S203-S205 in Embodiment 2, which are not described herein any further. Unlike Embodiment 2, this embodiment further includes the following steps:

S303: querying whether a locally stored mapping relationship between data identifies and data includes the data corresponding to the data identifiers, and if true, performing step S304, and otherwise, performing step S305; and

S304: acquiring the data corresponding to the data identifier, and returning the acquired data.

For example, when the received second data acquisition request carries data identifiers C1, DE and F1, as described in step S202, corresponding to the data selection condition. Table 3 is queried to acquire the data 101, 111, and 110 corresponding to the data identifiers C1, D1, and F1, and the acquired data is returned.

According to the embodiments of the present invention, data identifiers are determined according to a data selection condition, and all the data corresponding to the data identifiers is concurrently acquired according to the data identifiers, thereby reducing a data feedback delay caused by successive acquisition of data in the prior art. Concurrent acquisition of the data improves data acquisition efficiency, such that the data is timely feedback to a user and user satisfaction of a data user is enhanced. Furthermore, according to the embodiments of the present invention, the acquired data is cached such that when a user needs to acquire the data again, the user does not need to acquire the data from the background, but acquires the data in the local cache. This reduces the time for acquiring the data, and enhances user experience.

### Embodiment 4

As illustrated in FIG. 4, this embodiment provides a data acquisition device. The device includes:

a data acquisition request receiving module 401, configured to receive at least one first data acquisition request, where the first data acquisition request carries a data selection condition;

a data identifier acquiring module 402, configured to acquire all the data identifiers satisfying the data selection condition according to the data selection condition; and

a first data acquiring module 403, configured to concurrently acquire all the data corresponding to the data identifiers according to the data identifiers, and return the acquired data.

An embodiment of the present invention provides a terminal. The terminal includes the above described data acquisition device.

According to the embodiments of the present invention, all data identifiers satisfying the data selection condition are acquired, and all the data corresponding to the data identifiers are concurrently acquired according to the data identifiers, thereby reducing a data feedback delay caused by successive acquisition of data in the prior art. Concurrent acquisition of the data improves data acquisition efficiency, such that the data is timely fed back to a user and user satisfaction of a data user is enhanced.

### Embodiment 5

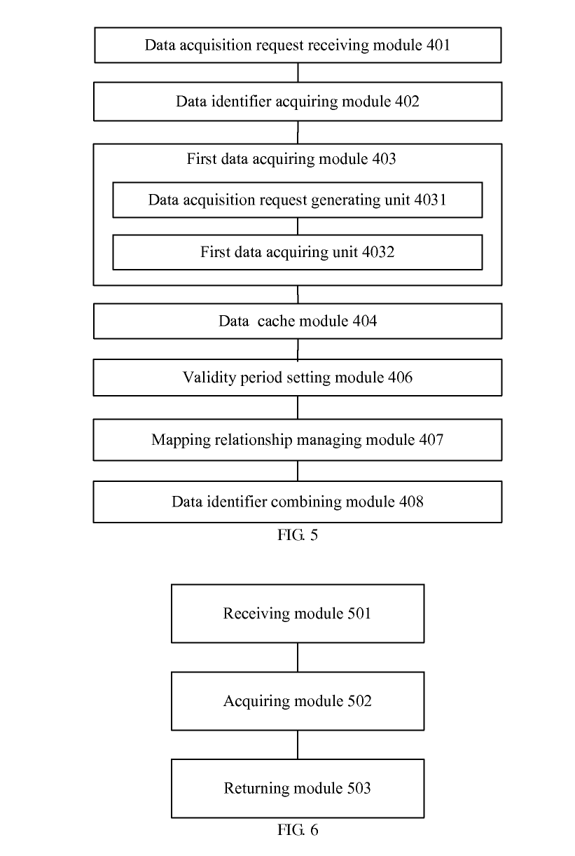

As illustrated in FIG. 5, this embodiment provides a data acquisition device. Similar to Embodiment 4, the device includes: the data acquisition request receiving module 401, the data identifier acquiring module 402, and the first data acquiring module 403 described in Embodiment 4.

Preferably, the first data acquiring module 403 specifically includes:

a data acquisition request generating unit 4031, configured to generate at least one second data acquisition request according to the data identifiers and a preset packet format, where the second data acquisition request is used to request the data corresponding to the data identifiers, and carries at least one data identifier, and the total number of bytes of the data identifiers is smaller than or equal to the maximum number of bytes allowed in the packet format; and

a first data acquiring unit 4032, configured to concurrently send the second data acquisition request to the data storage server, such that the data storage server acquires and returns the data corresponding to the data identifiers according to the data identifiers.

Optionally, the first data acquiring module is specifically configured to:

query whether a locally cached mapping relationship between data identifies and data includes the data corresponding to the data identifiers, and if true, acquire the data corresponding to the data identifiers; otherwise, generate at least one second data acquisition request according to the data identifiers and a preset packet format, where the second data acquisition request is used to request the data corresponding to the data identifiers, and carries at least one data identifier, and the total number of bytes of the data identifiers is smaller than or equal to the maximum number of bytes allowed in the packet format; and concurrently send the second data acquisition request to the data storage server, such that the data storage server, acquires and returns the data corresponding to the data identifiers according to the data identifiers.

Optionally, the device further includes:

a data cache module 404, configured to: judge whether the acquired data satisfies a preset cache condition; and if true, generate a mapping relationship between the data identifiers and the data, and cache the mapping relationship in the locally cached mapping relationship between data identifiers and data;

a validity period setting module 406, configured to set a validity period for the mapping relationship between the data identifiers and the data;

a mapping relationship managing module 407, configured to: if a duration when the mapping relationship between the data identifiers and the data is locally cached exceeds the validity period, delete the mapping relationship between the data identifiers and the data from the locally cached mapping relationship between data identifiers and data; and

a data identifier combining module 408, configured to combine all the data identifiers satisfying the data selection condition to obtain combined data identifiers, where the combined data identifiers include no identical data identifiers.

The first data acquiring module 403 is further configured to: concurrently acquire all the data corresponding to the combined data identifiers according to the combined data identifiers, and return the acquired data.

An embodiment of the present invention provides a terminal. The terminal includes the above described data acquisition device.

According to the embodiments of the present invention, data identifiers are determined according to a data selection condition, and all the data corresponding to the data identifiers is concurrently acquired according to the data identifiers, thereby reducing a data feedback delay caused by successive acquisition of data in the prior art. Concurrent acquisition of the data improves data acquisition efficiency, such that the data is timely feedback to a user and user experience in data acquisition is enhanced. Furthermore, according to the embodiments of the present invention, the acquired data is cached such that when a user needs to acquire the data again, the user does not need to acquire the data from the background, but acquires the data in the local cache. This reduces the time for acquiring the data, and enhances user experience.

### Embodiment 6

As illustrated in FIG. 6, this embodiment provides a data storage server, including: a receiving module 501, an acquiring module 502, and a returning module 503.

The receiving module 501 is configured to receive a second data acquisition request concurrently sent by a terminal, where the second data acquisition request is generated by the terminal according to data identifiers and a preset packet format.

The acquiring module 502 is configured to acquire the data corresponding to the data identifiers according to the data identifiers.

The returning module 503 is configured to return the data corresponding to the data identifiers acquired by the acquiring module 502.

Preferably, the acquiring module 502 is specifically configured to:

query in a mapping relationship between data identifies and data stored on a data storage server to acquire data corresponding to the data identifier of the generated second data acquisition request.

According to the embodiments of the present invention, a second data acquisition request that is concurrently sent by a terminal is received, and all data corresponding to the data identifiers are concurrently acquired according to the data identifiers, thereby reducing a data feedback delay caused by successive acquisition of data in the prior art. Concurrent acquisition of the data improves data acquisition efficiency, such that the data is timely fed back to a user and user experience in data acquisition is enhanced.

### Embodiment 7

This embodiment provides a data acquisition system. The system includes the terminal described in Embodiment 4 or 5, and the data storage server described in Embodiment 6.

According to the embodiments of the present invention, data identifiers are determined according to a data selection condition, and all the data corresponding to the data identifiers is concurrently acquired according to the data identifiers, thereby reducing a data feedback delay caused by successive acquisition of data in the prior art. Concurrent acquisition of the data improves data acquisition efficiency, such that the data is timely fed back to a user and user satisfaction of a data user is enhanced.

The device, terminal, data storage server, and system provided in this embodiment are based on the same inventive concept as the method embodiments. Therefore, the detailed implementation can refer to the description of the method embodiments of the present invention, which is not described herein any further.

All or part of the steps disclosed in the technical solutions according to the embodiments can be implemented by software programming. The programs may be stored in a computer readable storage medium, such as a read only memory (ROM), random access memory (RAM), a magnetic disk, or a compact disc-read only memory (CD-ROM).

Described above are merely preferred embodiments of the present invention, but are not intended to limit the present invention. Any modification, equivalent replacement, or improvement made without departing from the spirit and principle of the present invention should fall within the protection scope of the present invention.

1. A data acquisition method, comprising:
receiving at least one first data acquisition request, wherein the first data acquisition request carries a data selection condition;
acquiring all the data identifiers satisfying the data selection condition according to the data selection condition; and
concurrently acquiring all the data corresponding to the data identifiers according to the data identifiers, and returning the acquired data.

2. The method according to claim 1, wherein the concurrently acquiring all the data corresponding to the data identifiers according to the data identifiers specifically comprises:
generating at least one second data acquisition request according to the data identifiers and a preset packet format, wherein the second data acquisition request is used to request the data corresponding to the data identifiers, and carries at least one data identifier, and the total number of bytes of the data identifiers is smaller than or equal to the maximum number of bytes allowed in the packet format; and
concurrently sending the second data acquisition request to the data storage server, such that the data storage server acquires and returns the data corresponding to the data identifiers according to the data identifiers.

3. The method according to claim 1, wherein the concurrently acquiring all the data corresponding to the data identifiers according to the data identifiers, specifically comprises:
querying whether a locally cached mapping relationship between data identifies and data comprises the data corresponding to the data identifiers, and if true, acquiring the data corresponding to the data identifiers;
otherwise, generating at least one second data acquisition request according to the data identifiers and a preset packet format, wherein the second data acquisition request is used to request the data corresponding to the data identifiers, and carries at least one data identifier, and the total number of bytes of the data identifiers is smaller than or equal to the maximum number of bytes allowed in the packet format; and
concurrently sending the second data acquisition request to the data storage server, such that the data storage server acquires and returns the data corresponding to the data identifiers according to the data identifiers.

4. The method according to claim 2, wherein after the concurrently sending the second data acquisition request to the data storage server, such that the data storage server acquires and returns the data corresponding to the data identifiers according to the data identifiers, the method further comprises:
judging whether the acquired data satisfies a preset cache condition, and if true, generating a mapping relationship between the data identifiers and the data, and caching the mapping relationship in the locally cached mapping relationship between data identifiers and data.

5. The method according to claim 4, wherein after the judging whether the acquired data satisfies a preset cache condition, and if true, generating a mapping relationship between the data identifiers and the data, and caching the mapping relationship in the locally cached mapping relationship between data identifiers and data, the method further comprises:
setting a validity period for the mapping relationship between the data identifiers and the data; and
if a duration when the mapping relationship between the data identifiers and the data is locally cached exceeds the validity period, deleting the mapping relationship between the data identifiers and the data from the locally cached mapping relationship between data identifiers and data.

6. The method according to claim 1, wherein when at least two first data acquisition requests are received within a preset duration, after the acquiring all the data identifiers satisfying the data selection condition according to the data selection condition, the method further comprises:
combining all the data identifiers satisfying the data selection conditions to obtain combined data identifiers, wherein the combined data identifiers comprise no identical data identifiers; and
the concurrently acquiring all the data corresponding to the data identifiers according to the data identifiers, and returning the acquired data comprises:
concurrently acquiring all the data corresponding to the combined data identifiers according to the combined data identifiers, and returning the acquired data.

7. A data acquisition device, comprising:
a data acquisition request receiving module, configured to receive at least one first data acquisition request, wherein the first data acquisition request carries a data selection condition;
a data identifier acquiring module, configured to acquire all the data identifiers satisfying the data selection condition according to the data selection condition; and
a first data acquiring module, configured to concurrently acquire all the data corresponding to the data identifiers according to the data identifiers, and return the acquired data.

8. The device according to claim 7, wherein the first data acquiring module specifically comprises:
a data acquisition request generating unit, configured to generate at least one second data acquisition request according to the data identifiers and a preset packet format, wherein the second data acquisition request is used to request the data corresponding to the data identifiers, and carries at least one data identifier, and the total number of bytes of the data identifiers is smaller than or equal to the maximum number of bytes allowed in the packet format; and
a first data acquiring unit, configured to concurrently send the second data acquisition request to the data storage server, such that the data storage server acquires and returns the data corresponding to the data identifiers according to the data identifiers.

9. The device according to claim 7, wherein the first data acquiring module is specifically configured to:
query whether a locally cached mapping relationship between data identifies and data comprises the data corresponding to the data identifiers, and if true, acquire the data corresponding to the data identifiers; otherwise, generate at least one second data acquisition request according to the data identifiers and a preset packet format, wherein the second data acquisition request is used to request the data corresponding to the data identifiers, and carries at least one data identifier, and the total number of bytes of the data identifiers is smaller than or equal to the maximum number of bytes allowed in the packet format; and concurrently send the second data acquisition request to the data storage server, such that the data storage server, acquires and returns the data corresponding to the data identifiers according to the data identifiers.

10. The device according to claim 8, further comprising:
a data cache module, configured to: judge whether the acquired data satisfies a preset cache condition; and if true, generate a mapping relationship between the data identifiers and the data, and cache the mapping relationship in the locally cached mapping relationship between data identifiers and data.

11. The device according to claim 10, further comprising:
a validity period setting module, configured to set a validity period for the mapping relationship between the data identifiers and the data; and
a mapping relationship managing module, configured to: if a duration when the mapping relationship between the data identifiers and the data is locally cached exceeds the validity period, delete the mapping relationship between the data identifiers and the data from the locally cached mapping relationship between data identifiers and data.

12. The device according to claim 7, further comprising:
a data identifier combining module, configured to combine all the data identifiers satisfying the data selection conditions to obtain combined data identifiers, wherein the combined data identifiers comprise no identical data identifiers;
wherein the first data acquiring module is further configured to: concurrently acquire all the data corresponding to the combined data identifiers according to the combined data identifiers, and return the acquired data.

13. (canceled)

14. (canceled)

15. (canceled)

16. (canceled)

17. A terminal, comprising a data acquisition device which comprises:
a data acquisition request receiving module, configured to receive at least one first data acquisition request, wherein the first data acquisition request carries a data selection condition;
a data identifier acquiring module, configured to acquire all the data identifiers satisfying the data selection condition according to the data selection condition; and
a first data acquiring module, configured to concurrently acquire all the data corresponding to the data identifiers according to the data identifiers, and return the acquired data.

18. The terminal according to claim 17, wherein the first data acquiring module specifically comprises:
a data acquisition request generating unit, configured to generate at least one second data acquisition request according to the data identifiers and a preset packet format, wherein the second data acquisition request is used to request the data corresponding to the data identifiers, and carries at least one data identifier, and the total number of bytes of the data identifiers is smaller than or equal to the maximum number of bytes allowed in the packet format; and
a first data acquiring unit, configured to concurrently send the second data acquisition request to the data storage server, such that the data storage server acquires and returns the data corresponding to the data identifiers according to the data identifiers.

19. The terminal according to claim 18, wherein the data acquisition device further comprises:
a data cache module, configured to: judge whether the acquired data satisfies a preset cache condition; and if true, generate a mapping relationship between the data identifiers and the data, and cache the mapping relationship in the locally cached mapping relationship between data identifiers and data.

20. The terminal according to claim 19, wherein the data acquisition device further comprises:
a validity period setting module, configured to set a validity period for the mapping relationship between the data identifiers and the data; and
a mapping relationship managing module, configured to: if a duration when the mapping relationship between the data identifiers and the data is locally cached exceeds the validity period, delete the mapping relationship between the data identifiers and the data from the locally cached mapping relationship between data identifiers and data.

21. The terminal according to claim 17, wherein the first data acquiring module is specifically configured to:
query whether a locally cached mapping relationship between data identifies and data comprises the data corresponding to the data identifiers, and if true, acquire the data corresponding to the data identifiers; otherwise, generate at least one second data acquisition request according to the data identifiers and a preset packet format, wherein the second data acquisition request is used to request the data corresponding to the data identifiers, and carries at least one data identifier, and the total number of bytes of the data identifiers is smaller than or equal to the maximum number of bytes allowed in the packet format; and concurrently send the second data acquisition request to the data storage server, such that the data storage server, acquires and returns the data corresponding to the data identifiers according to the data identifiers.

22. The terminal according to claim 17, wherein the data acquisition device further comprises:
a data identifier combining module, configured to combine all the data identifiers satisfying the data selection conditions to obtain combined data identifiers, wherein the combined data identifiers comprise no identical data identifiers;
wherein the first data acquiring module is further configured to: concurrently acquire all the data corresponding to the combined data identifiers according to the combined data identifiers, and return the acquired data.

23. A data acquisition system, comprising a terminal and a data storage server, wherein the terminal comprises the data acquisition device of claim 7, wherein the data storage server comprises:
a receiving module, configured to receive a second data acquisition request concurrently sent by a terminal, wherein the second data acquisition request is generated by the terminal according to data identifiers and a preset packet format;
an acquiring module, configured to acquire the data corresponding to the data identifiers according to the data identifiers; and
a returning module, configured to return the data corresponding to the data identifiers acquired by the acquiring module.

24. The data acquisition system according to claim 23, wherein the acquiring module is specifically configured to:
query in a mapping relationship between data identifies and data stored on a data storage server to acquire data corresponding to the data identifier of the generated second data acquisition request.
